(19) United States
(12) Patent Application Publication
(10) Pub. No.: US 2009/0019212 A1
(43) Pub. Date: Jan. 15, 2009

(54) Flash disk of phone book

(75) Inventors: Shaw-Hwa Hwang, Taipei City (TW); Kuo-En Hung, Banciao City (TW)

Correspondence Address: BACON & THOMAS, PLLC, 625 SLATERS LANE, FOURTH FLOOR, ALEXANDRIA, VA, 22314-1176, US

(73) Assignee: Color City Enterprise Co., Ltd., Apia (WS)

(21) Appl. No.: 11/826,081

(22) Filed: Jul. 12, 2007

(51) Int. Cl. G06F 12/00; G06F 15/00

(52) U.S. Cl. 711/103; 715/234; 711/E12.008

(57) ABSTRACT

The present invention provides a flash disk of phone book, it comprises an autorun part, a phone book part and a free use part.

The autorun part includes programs for displaying related information on a monitor of a computer when a subscriber plugs the flash disk of phone book into the computer.

The phone book part comprises many webpages and phone numbers of many companies and individuals for being displayed on the monitor of the computer. XML or HTML can be used for developing webpages.

The free use part is just the same as an ordinary flash disk, and can be used by the subscriber freely.

The phone book part sets up an ActiveX component on each webpage of the companies and individuals. Each ActiveX component includes VoIP related software and a service phone number of a company or an individual.

### FIELD OF THE INVENTION

The present invention relates to a flash disk of phone book, and more particularly to a flash disk that can be used to search the phone number by a computer and dial the phone number via Internet.

### BACKGROUND OF THE INVENTION

Conventionally a phone book is provided by a telecommunication company to each subscriber, and the subscriber can search the required phone number from the phone book, then dial the phone number by an ordinary phone. This kind of operation is very slow in searching the required phone number, and sometimes it is not very easy to find the most suitable phone number.

Since flash disk, personal computer and Internet are very popular today, a new design for phone book can be established on a flash disk for the subscriber to search the required phone number by a computer and dial directly via Internet.

### SUMMARY OF THE INVENTION

The object of the present invention is to provide a flash disk of phone book. It comprises three parts: an autorun part, a phone book part and a free use part.

The autorun part includes programs for displaying related information on a monitor of a computer when a subscriber plugs the flash disk of phone book into the computer.

The phone book part comprises many webpages and phone numbers of many companies and individuals for being displayed on a monitor of a computer. XML or HTML can be used for developing webpages.

The free use part is just the same as an ordinary flash disk, and can be used by the subscriber freely.

The phone book part sets up an ActiveX component on each webpage of the companies and individuals. The ActiveX component includes VoIP related software and a service phone number. When a subscriber plugs the flash disk of phone book into a computer, clicks a webpage of a company or individual, the ActiveX component will be shown as “Dialing” icon on the monitor of the computer. The subscriber clicks the “Dialing” icon, the computer therefore automatically uses the service phone number stored in the ActiveX component to dial out a web call via Internet browser, and connect the subscriber to the service phone of a company or an individual.

The phone book part also includes the background information of each company, web page for carrying advertising and a phone number thereof, life information and travel information and phone numbers thereof.

### BRIEF DESCRIPTION OF THE DRAWING

FIG. 1 shows schematically a flash disk of phone book according to the present invention.

FIG. 2 shows schematically a front page of the phone book according to the present invention.

FIG. 3 shows schematically a subscriber searches the phone book by key word.

FIG. 4 shows schematically a picture of “Dialing On” according to the present invention.

FIG. 5 shows schematically a web page for carrying advertising according to the present invention.

FIG. 6 shows schematically a picture of life information according to the present invention.

FIG. 7 shows schematically a picture of travel information according to the present invention.

### DETAILED DESCRIPTION OF THE PREFERRED EMBODIMENTS

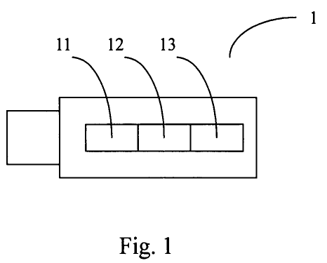

Referring to FIG. 1, a flash disk 1 of phone book according to the present invention is shown. The flash disk 1 comprises three parts: an autorun part 11, a phone book part 12 and a free use part 13. The free use part 13 is just the same as an ordinary flash disk, and can be used by the subscriber freely.

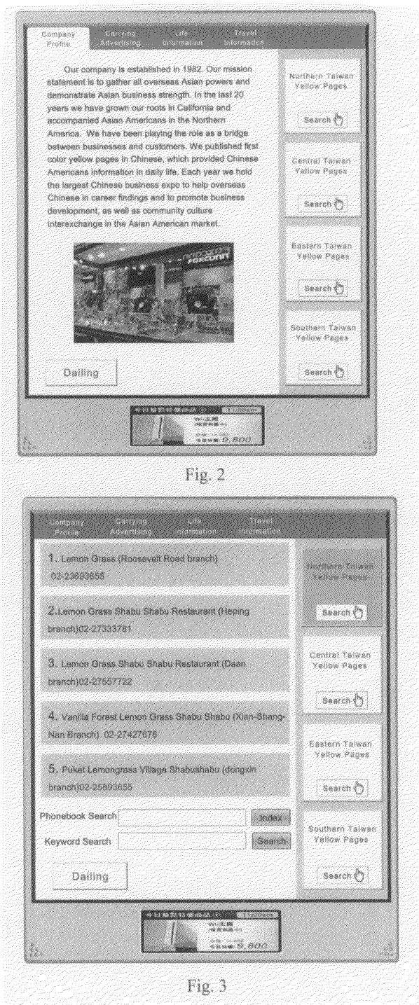

The autorun part 11 includes programs for displaying related information on a computer monitor automatically when a subscriber plugs the flash disk 1 into the computer, as shown in FIG. 2. FIG. 2 shows the front page of the phone book part 12, the right side thereof shows phone books of “Northern Taiwan”, “Central Taiwan”, “Eastern Taiwan” and “Southern Taiwan”. After the subscriber clicks the “search” icon, FIG. 3 is shown. In FIG. 3, the subscriber can search the phone book or input keywords to search. The upper side of the front page of the phone book part 12 shows “Company Background”, “Carrying Advertising”, “Life Information”, “Travel Information” for the subscriber to click. If the subscriber clicks “Company Background”, and then clicks one of the phone book at the right side, FIG. 3 will be shown, In FIG. 3, the subscriber can search the phone book or input keywords to search related company, and the introductory page of the related company will be shown as in FIG. 2. Thereafter the subscriber clicks the “Dialing” icon at the lower left part of FIG. 2, the computer will then dial the phone number of the related company automatically via Internet.

The phone book part 12 comprises many webpages and phone numbers of many companies and individuals for being displayed on a monitor of a computer. XML or HTML can be used for developing webpages.

The function of “Dialing” is described as below:

“Dialing” is an automatic web-call service via Internet browser, a VoIP related software and a service phone number of a company or an individual are packaged into an ActiveX component; and then applying CodeSigning service from VeriSign Company for conducting digital signature; finally the ActiveX component is installed on the introductory page of the company in the phone book part 12, and shown as “Dialing” icon on the monitor of the computer.

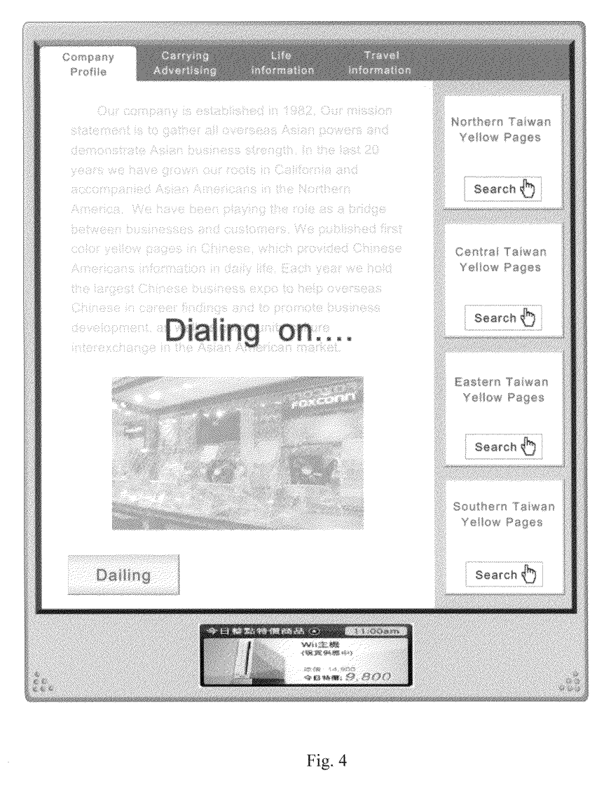

After the subscriber clicks the “Dialing” icon on the monitor of the computer, a picture of “Dialing On” is shown as FIG. 4, and then the computer will automatically dial out a web-call via Internet browser by using the AxtiveX component stored in the “Dialing” icon to dial out the related service phone number of the company or individual, and connect the subscriber to the service phone of the selected company or individual.

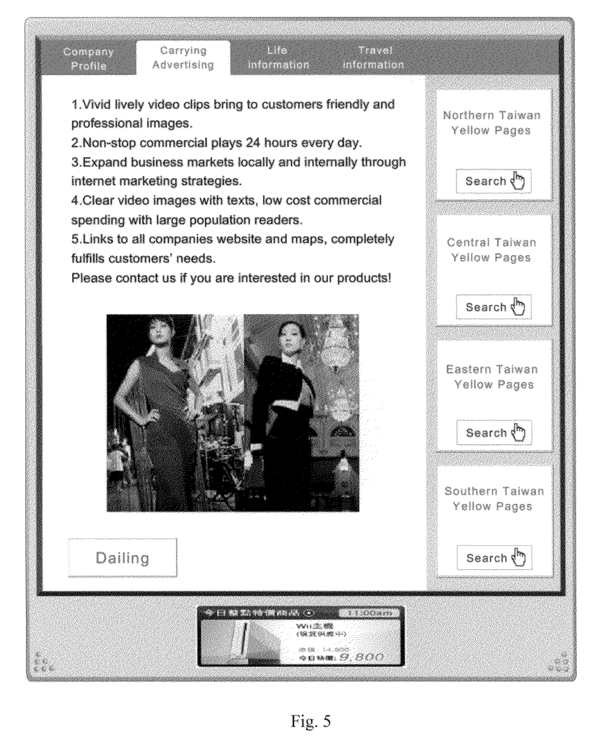

If the subscriber clicks the “Carrying Advertising” icon, a picture of FIG. 5 will be shown. After the subscriber clicks the “Dialing” icon on the monitor of the computer, the computer will automatically dial out a web-call via Internet browser by using the AxtiveX component stored in the “Dialing” icon to dial out the related service phone number of the advertising company, and connect the subscriber to the service phone of the advertising company for discussing advertising affairs.

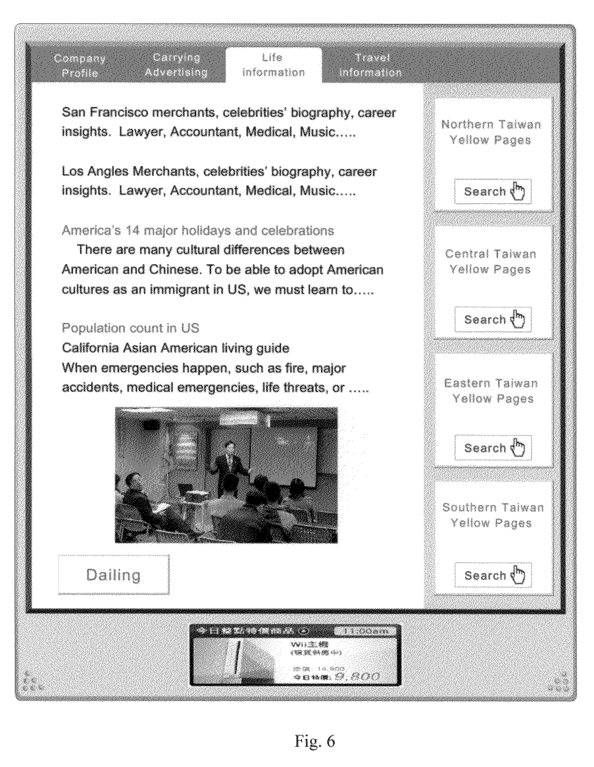

If the subscriber clicks the “Life Information” icon, a picture of FIG. 6 will be shown. After the subscriber clicks one of the information shown on the picture, the computer will automatically dial out a web-call via Internet browser by using the AxtiveX component stored in the “Dialing” icon to dial out the related service phone number of the information, and connect the subscriber to the service phone of the information for discussing related affairs.

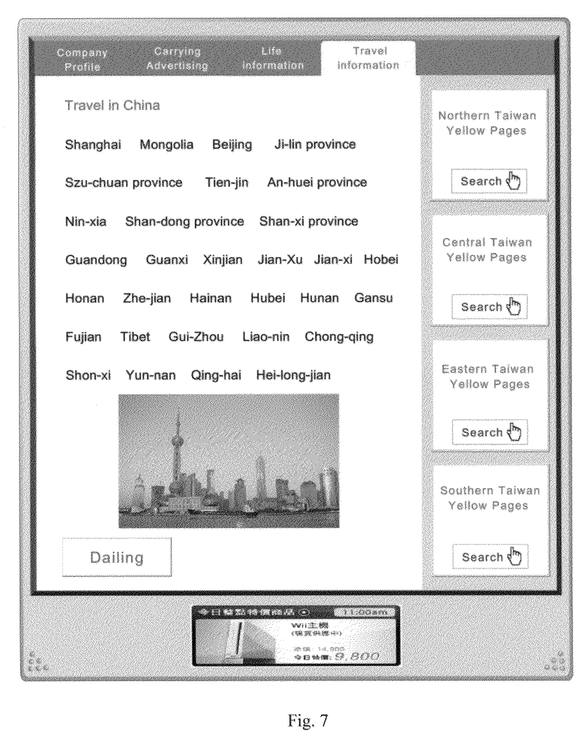

If the subscriber clicks the “Travel Information” icon, a picture of FIG. 7 will be shown. After the subscriber clicks one of the travel information shown on the picture, the computer will automatically dial out a web-call via Internet browser by using the AxtiveX component stored in the “Dialing” icon to dial out the related service phone number of the travel information, and connect the subscriber to the service phone of the travel information for discussing traveling affairs.

The scope of the present invention depends upon the following claims, and is not limited by the above embodiments.

What is claimed is:

1. A flash disk of phone book, comprising:
an autorun part, including programs for displaying related information on a monitor of a computer automatically when a subscriber plugs the flash disk of phone book into the computer;
a phone book part, including many webpages and phone numbers of many companies and individuals for being displayed on the monitor of the computer;
a free use part, which is just the same as an ordinary flash disk, and can be used by the subscriber freely.

2. The flash disk of phone book according to claim 1, wherein the phone book part sets up an ActiveX component on each webpage of the companies and individuals; the ActiveX component includes VoIP related software and a service phone number; when the subscriber plugs the flash disk of phone book into the computer, clicks a webpage of a company or individual, the ActiveX component will be shown as “Dialing” icon on the monitor of the computer; the subscriber clicks the “Dialing” icon, the computer therefore uses the service phone number stored in the ActiveX component to dial out a web call via Internet browser, and connect the subscriber to the service phone of the company or the individual.

3. The flash disk of phone book according to claim 1, wherein the phone book part includes background information of each company.

4. The flash disk of phone book according to claim 1, wherein the phone book part includes web page for carrying advertising and a phone number thereof.

5. The flash disk of phone book according to claim 1, wherein the phone book part includes web pages of life information or travel information and phone numbers thereof.

6. The flash disk of phone book according to claim 1, wherein XML or HTML can be used for developing webpages.
